(19) United States
(12) Patent Application Publication
(10) Pub. No.: US 2023/0237767 A1
(43) Pub. Date: Jul. 27, 2023

(54) CUSTOM DIGITAL STAMP PATTERN DETECTOR FOR COPY SECURITY FUNCTION

(71) Applicant: KYOCERA Document Solutions, Inc., Osaka (JP)

(72) Inventors: Dongpei Su, Palos Verdes Estates, CA (US); Kilho Shin, Los Angeles, CA (US)

(73) Assignee: KYOCERA Document Solutions, Inc., Osaka (JP)

(21) Appl. No.: 17/586,579

(22) Filed: Jan. 27, 2022

(51) Int. Cl. G06V 10/75; G06V 10/22; G06T 3/40; G06V 10/62; G06F 21/60

(52) U.S. Cl. CPC G06V 10/757; G06V 10/22; G06T 3/40; G06V 10/62; G06F 21/60

(57) ABSTRACT

A method and apparatus for detecting a digital stamp pattern are disclosed. Keypoints and descriptors are extracted from an original template pattern image. A low resolution original document and at least one lower resolution template pattern image are template-matched to detect a matched region based on match correlation coefficients. This region is cropped out of a full resolution original document. Keypoints and descriptors are extracted from the cropped region, and are matched with stamp pattern keypoints and descriptors using feature based pattern matching. A transformation matrix is used to detect scaling, rotation, and translation of a detected digital stamp pattern in the cropped region. A number of qualified matches determined using feature based pattern matching or the transformation matrix are checked against a pre-set threshold. If a pre-set threshold is exceeded, an alert is generated for a possible security issue. Otherwise, a no security issues signal may be generated.

### BACKGROUND

Many offices have documents with sensitive information that need to be kept private and secure. Digital copy guard stamps (with text of “Confidential”, “Top Secret”, “Classified”, “Do not Copy”, etc.) are one popular technique. These stamps with security keywords may indicate the confidential nature on the document, and remind people not to make casual photocopies without permission.

Detecting these copy guard stamps during a copying operation would allow an additional layer of security in situations when personnel inadvertently or illicitly attempt a copying operation on stamped documents. This detection is made difficult, however, by the limitless variation of size, shape, font, and style in such stamps. As a result, conventional optical character recognition (OCR) based detection and deep learning based detection have had limited success. To cope with custom stamps, pattern matching based approaches may be a better choice.

“Pattern matching” refers to detecting a known pattern in an image by comparing their similarity. This method is particularly useful if the pattern structure is arbitrary. There are two major types of pattern matching approaches: template based, and feature based.

“Template based pattern matching” refers to comparing the template (pattern) image against the query image by sliding it. The template image is moved one pixel at a time from left to right or from top to bottom to enable to calculate some numerical measure of similarity to the patch it overlaps. Both images are converted into binary images or in black and white, or converted to edge image by running through an edge filter. Then template matching techniques like normalized cross-correlation, cross-correlation, and sum of squared difference are applied. After looping through all sizes, take the region with the largest correlation coefficient and use that as the “matched” region.

“Feature based pattern matching” refers to four main steps: feature detection, feature extraction, feature matching, and computing affinity. Image features, such as edges and interest points, provide rich information on the image content. Local features and their descriptors are the building blocks of many computer vision algorithms. Their applications include image registration, object detection and classification, tracking, and motion estimation. These features are exclusive for each image, and thus help in identifying similarities and differences between images. The features of an image may persist through changes in size and orientation, so this approach may further prove useful where the match in a scanned image is transformed in some fashion.

However, template based matching is not robustly scale- or rotation-invariant and is very slow at high resolution. In addition, copy stamp detection may need to be fully automated, leaving no place for human confirmation of a result. This prevents reliance on template based pattern matching, because the similarity score used in this approach may be highly dependent on image content. A very well matched pattern in one image may have a lower similarity score than a poorly matched different pattern-query pair. In other words, the similarity score is a “relative measure”. There is no threshold that works universally for most images.

Feature based pattern matching may be invariant to scale, rotate, translation, illumination, and blur. Therefore, when used on high resolution images, a feature based pattern matching may robustly detect a large number of key points/features. A constant threshold value (number of consistently matched key points) may be used for a quantitative final judgment, without human confirmation. Feature based pattern matching, however, is also slow at high resolution, and down-scaled images may have too few detectable features, and the features detected may lack enough uniqueness, to perform effective feature based pattern matching.

There is therefore a need for a solution that quickly and accurately detects the presence of a copy guard stamp during a copying operation without need for human intervention.

### BRIEF SUMMARY

This disclosure relates to method of detecting a digital stamp pattern and an apparatus for performing the same. The method includes extracting stamp pattern keypoints and stamp pattern descriptors from an original template pattern image of the digital stamp pattern. The method also includes running a template matching routine between a low resolution original document and at least one lower resolution template pattern image, where match correlation coefficients are determined by regions in the low resolution original document. The method also includes selecting a matched region in the low resolution original document based on the match correlation coefficients. The method also includes cropping out a cropped region in a full resolution original document corresponding to the matched region in the low resolution original document. The method also includes extracting cropped region keypoints and cropped region descriptors in the cropped region. The method also includes matching the cropped region keypoints and the cropped region descriptors in the cropped region with stamp pattern keypoints and stamp pattern descriptors using a feature based pattern matching routine. The method also includes computing a transformation matrix using coordinates for the stamp pattern keypoints and coordinates for the cropped region keypoints to detect at least one of scaling, rotation, and translation of a detected digital stamp pattern in the cropped region relative to the original template pattern image. The method also includes checking a number of qualified matches determined using at least one of the feature based pattern matching and the transformation matrix against a pre-set threshold. On condition the number of qualified matches exceeds the pre-set threshold, the method includes issuing an alert for a possible security issue. On condition the number of qualified matches does not exceed the pre-set threshold, the method includes issuing a signal indicating no security issues.

The apparatus disclosed herein includes a processor and a memory. The memory stores instructions that, when executed by the processor, allow the apparatus to perform the disclosed method.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a feature based pattern matching flow 100 in accordance with one embodiment.

FIG. 2 illustrates a full page feature extraction 200 in accordance with one embodiment.

FIG. 3 illustrates a low resolution feature extraction 300 in accordance with one embodiment.

FIG. 4 illustrates a routine 400 in accordance with one embodiment.

FIG. 5 illustrates a routine 500 in accordance with one embodiment.

FIG. 6 illustrates an original template pattern image from digital stamp pattern 600 in accordance with one embodiment.

FIG. 7A illustrates an original template pattern image at 600 dpi 700a in accordance with one embodiment.

FIG. 7B illustrates a 200 dpi scan 700b of the original template pattern image at 600 dpi 700a in accordance with one embodiment.

FIG. 7C illustrates a 180 dpi scan 700c of the original template pattern image at 600 dpi 700a in accordance with one embodiment.

FIG. 7D illustrates a 160 dpi scan 700d of the original template pattern image at 600 dpi 700a in accordance with one embodiment.

FIG. 7E illustrates a 140 dpi scan 700e of the original template pattern image at 600 dpi 700a in accordance with one embodiment.

FIG. 7F illustrates a 120 dpi scan 700f of the original template pattern image at 600 dpi 700a in accordance with one embodiment.

FIG. 7G illustrates a 100 dpi scan 700g of the original template pattern image at 600 dpi 700a in accordance with one embodiment.

FIG. 8 illustrates a full resolution original document 800 in accordance with one embodiment.

FIG. 9 illustrates a template matching process 900 in accordance with one embodiment.

FIG. 10 illustrates a cropped region at full resolution 1000 in accordance with one embodiment.

FIG. 11 illustrates a feature matching at full resolution 1100 in accordance with one embodiment.

FIG. 12 illustrates affine transformation 1200 at a high level.

FIG. 13 illustrates homography transformation 1300 at a high level.

FIG. 14 is an example block diagram of a computing device 1400 that may incorporate embodiments of the present disclosure.

### DETAILED DESCRIPTION

In copy workflow, the disclosed solution for embedded security stamp detection in a multifunction printer (MFP) may quickly, automatically, and accurately detect pattern(s) matching with pre-configured security stamps, with no need for human intervention. Once such a stamp pattern detected, actions (such as stop copying, report to administrator, printing blank page, etc.) may be taken to enforce corporate security rules.

In a copy protection application, a scanned page may have a high resolution, such as 600 dots per inch (dpi), in order to provide a high-quality copied output. To perform security stamp detection during a real-time copying job, where the MFP engine speed may exceed 60 pages per minute (ppm), the scanned image may be scaled down in resolution to speed up the calculations needed to perform detection processes. “Copy protection” also known as content protection, copy prevention and copy restriction, is any effort designed to prevent the reproduction of document for security or copyright reasons. To prevent unauthorized copy, security key words are often overlaid on the document page when print, in the form of digital watermarks, stamps, or special nested patterns.

Based on the unique scope and requirement of stamp copy guard detection, this disclosure uses two pattern matching techniques in a two-stage approach to security stamp detection on a page inserted into an MFP or similar device for copying or scanning. “Copy guard detection” refers to, for security purposes, scanner/MFP automatically examines the content of a scanned-in page using computer vision techniques, to check against pre-set copy guard pattern, in order to prevent/report unauthorized copy.

The first stage uses template based pattern matching at low resolution to provide a relative best match localization, detecting the area where a copy protection stamp may be located. The second stage uses feature based pattern matching on the identified smaller area, at high resolution, for robust automatic detection judgment. This combination may provide the advantages of both template based and feature based approaches, while mitigating the drawbacks encountered using each approach singly.

In the first stage, the inserted page is scanned and downscaled to a fairly low resolution, and template based pattern matching may be performed with a preset copy security stamp scaled to a similar resolution. The rotation variation of the stamp on a scanned page may be small (e.g., less than two degrees). The scale variation may typically be small as well. The small amount of rotation and scaling that may be expected in a scanned page make template based pattern matching a practical approach, even at low resolution. In cases with greater scale variation than may be handled with a single template, multiple templates at different scales may be applied during template matching. When a match is detected within a region of the scanned document through template based pattern matching, the matched region may be cropped from a full resolution image of the scanned document.

In the second stage, feature based pattern matching between the cropped full resolution image and security stamp may be performed more expeditiously than on the full scanned page, the regions processed being smaller and containing less extraneous data. This disclosed method and apparatus may thus provide a good combination of speed and accuracy and may meet the fully-automated requirement of a copy job.

While the disclosed solution is presented as facilitating document security against unauthorized duplication, its applications are not limited thereto. This solution may be used to detect document patterns and logos that are not specifically copy security stamps. It may also be extended to a general approach for quick and effective pattern detection in documents run through an MFP.

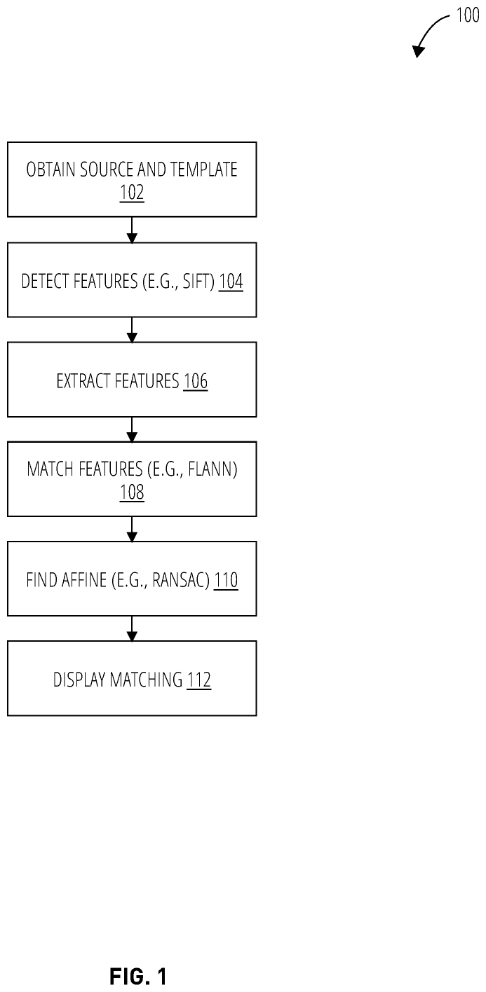

FIG. 1 illustrates a general feature based pattern matching flow 100 in accordance with one embodiment of the present disclosure. The feature based pattern matching flow 100 begins at block 102, where a source and a template are obtained for comparison. The source may be, in the disclosed embodiments, the cropped region of the full resolution original document, while the template may be the original template pattern image created containing on the digital stamp pattern.

At block 104, features may be detected in the source and template. A Scale-Invariant Feature Transform (SIFT) algorithm may be used to detect features. Detected features may then be extracted at block 106. Feature extraction may result in a keypoint and a description associated with each feature.

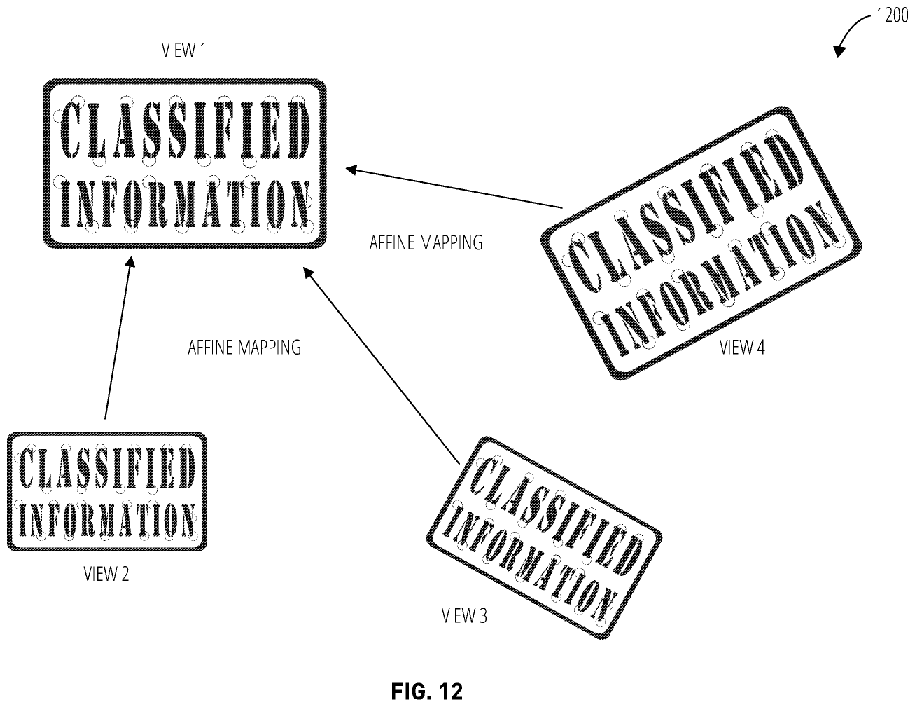

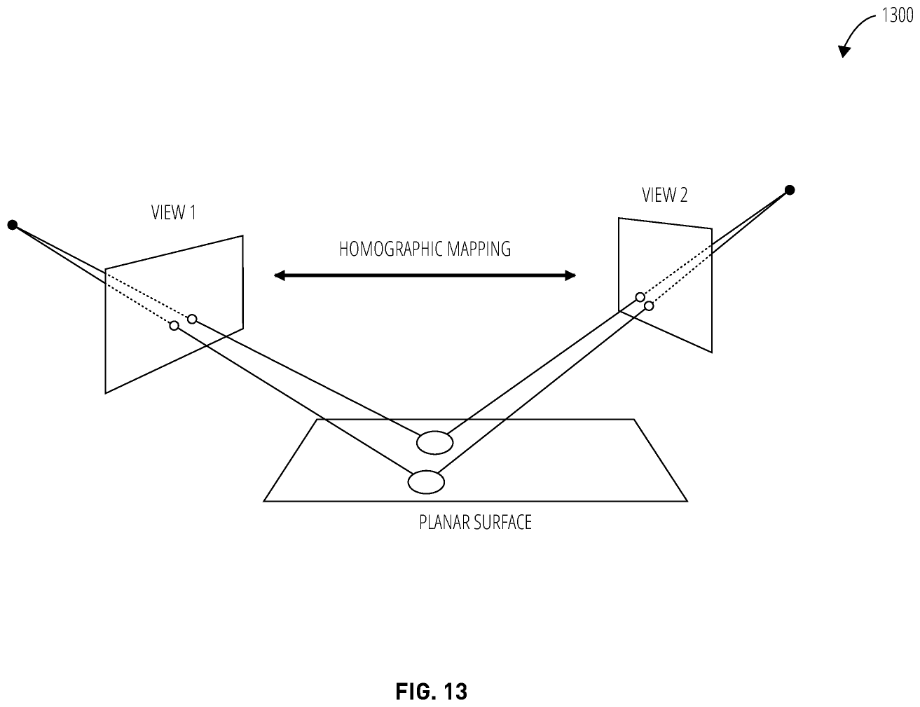

Features extracted in block 106 from the source and template of block 102 may be matched in block 108. A Fast Library for Approximate Nearest Neighbors (FLANN) may be used. An affine between the two sets of features may be computed using a Random Sample Consensus (RANSAC) algorithm at block 110. Affine transformation is described with respect to FIG. 12. In some embodiments, homography may be computed using RANSAC. Homography transformation is described with respect to FIG. 13.

In block 112, matching between the source and template may be displayed. In some embodiments, matching may be returned for use in additional process steps as a set of match correlation coefficients, a number of qualified matches, or a Boolean value indicating whether or not the number of qualified matches exceeds a pre-set threshold.

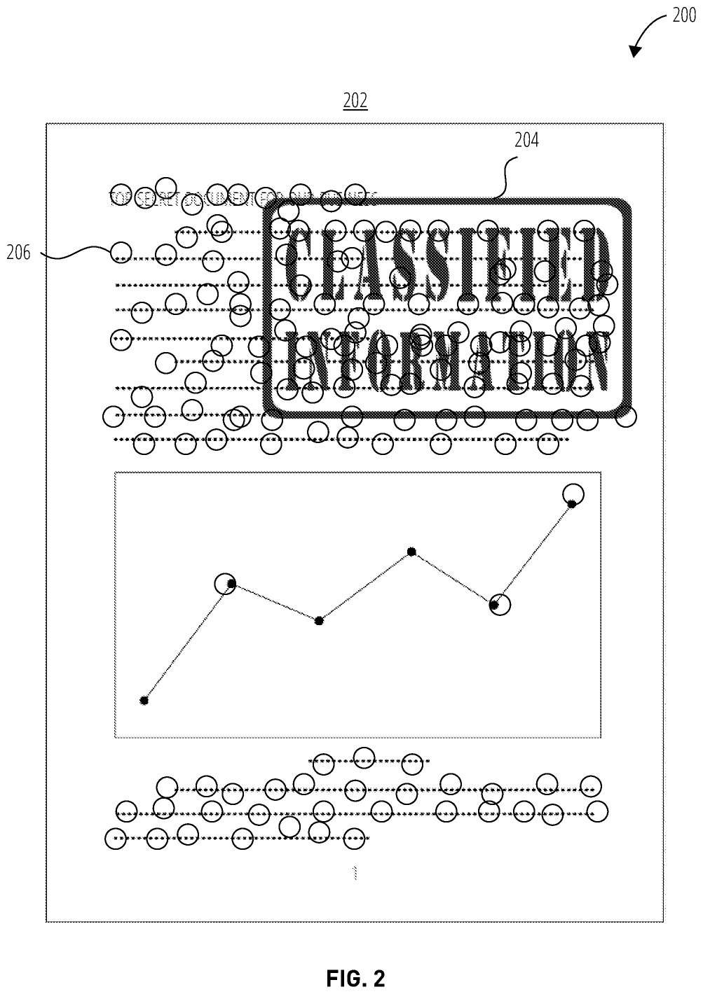

FIG. 2 illustrates a full page feature extraction 200 in accordance with one embodiment. A feature extraction for the purpose of feature based pattern matching performed on a full page, at full resolution, such as full resolution original document 202, which is marked with a copy guard detection stamp 204, may return hundreds of feature keypoints and descriptors 206.

The feature keypoints and descriptors 206 are indicated by the circles in this drawing in a greatly simplified manner. While hundreds of features may be detected during feature extraction, many potential feature keypoints and descriptors 206 have been omitted in this illustration for the sake of clarity.

As illustrated in FIG. 2, the majority of the returned feature keypoints and descriptors 206 detected in the full resolution original document 202 may apply to areas of the page not associated with the copy guard detection stamp 204. Both the time needed to detect features across a page scanned at full resolution (e.g., 600 dpi), and the time spent comparing many extraneous features unrelated to the copy guard detection stamp 204, make feature based pattern matching on an entire full-resolution page, impractical during a real-time printing operation.

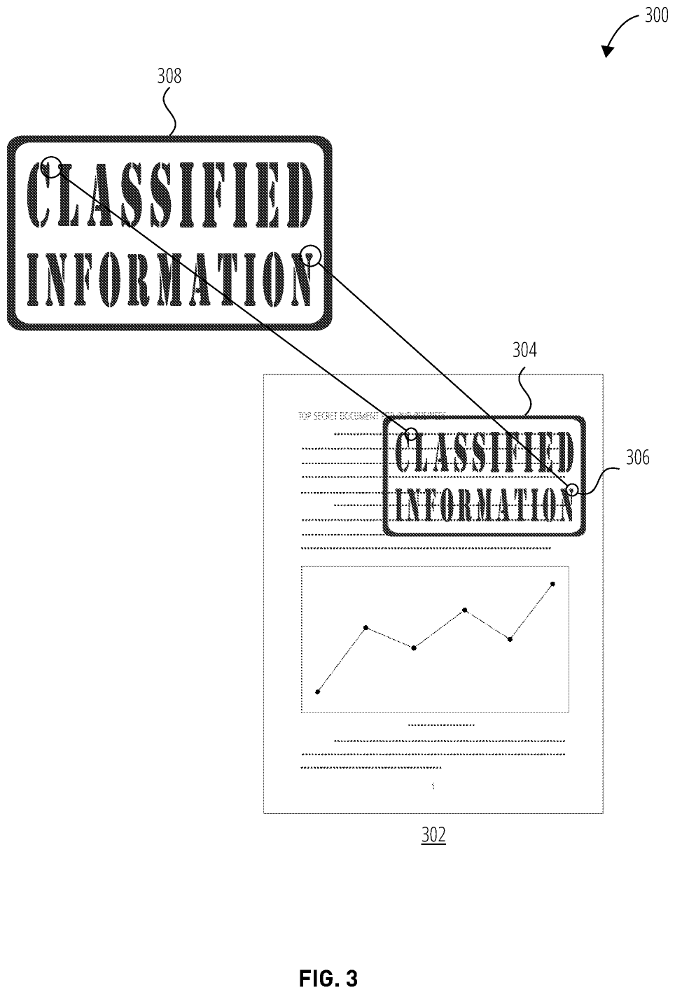

FIG. 3 illustrates a low resolution feature extraction 300 in accordance with one embodiment. A low resolution original document 302 stamped with a copy guard detection stamp 304, when scanned for feature extraction, may yield very few feature keypoints and descriptors 306 within the area of interest, around the copy guard detection stamp 304. When very few features are extracted, a match cannot be made between the copy guard detection stamp 304 and an original template pattern image 308 with an acceptable level of confidence.

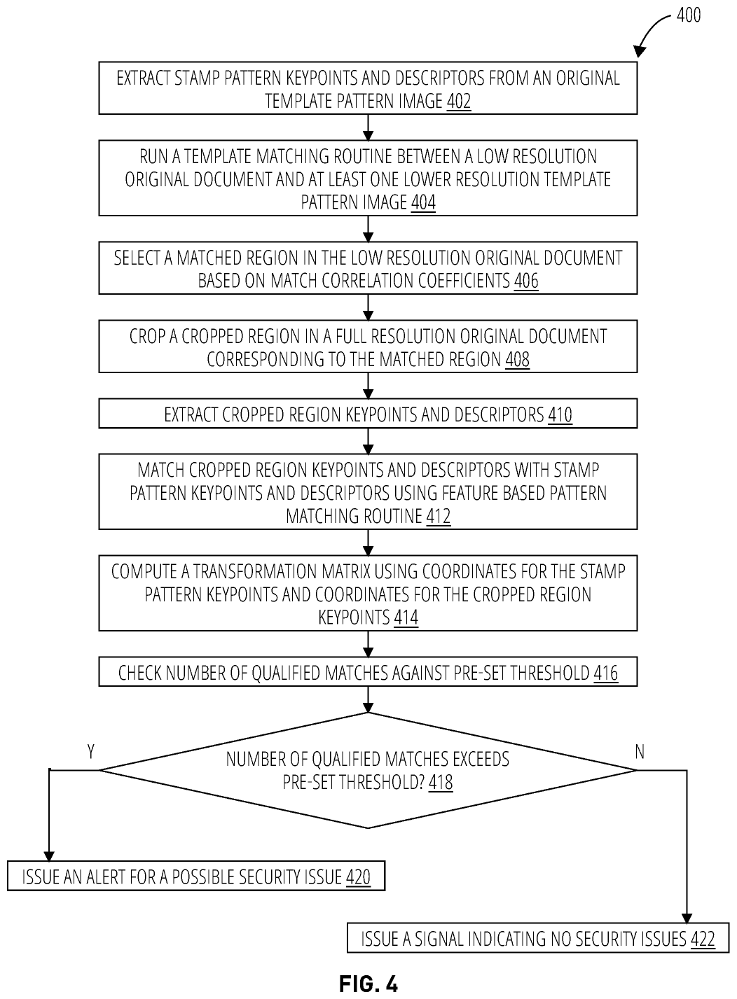

FIG. 4 illustrates a routine 400 in accordance with one embodiment. In block 402, the routine 400 begins with extract stamp pattern keypoints and stamp pattern descriptors from an original template pattern image of the digital stamp pattern. These stamp pattern keypoints and stamp pattern descriptors constitute the stamp pattern features that may be used for future feature based pattern matching.

In block 404, a template matching routine may be run between a low resolution original document and at least one lower resolution template pattern image. Template based pattern matching may be run using a template matching routine such as a Python Open Computer Vision (CV) Template Matching algorithm on the low resolution original document and at least one lower resolution template pattern image.

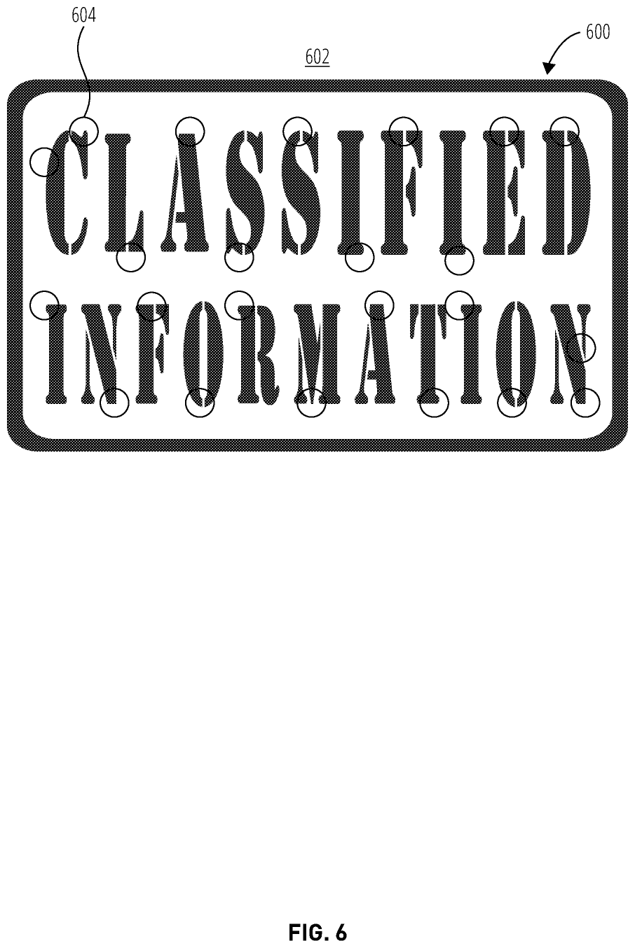

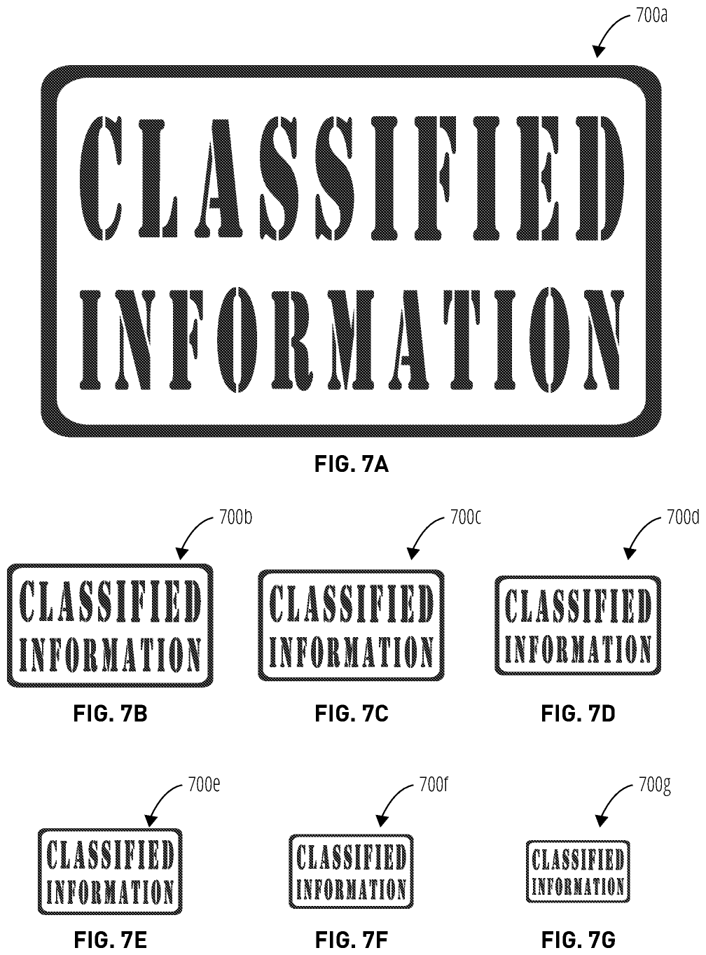

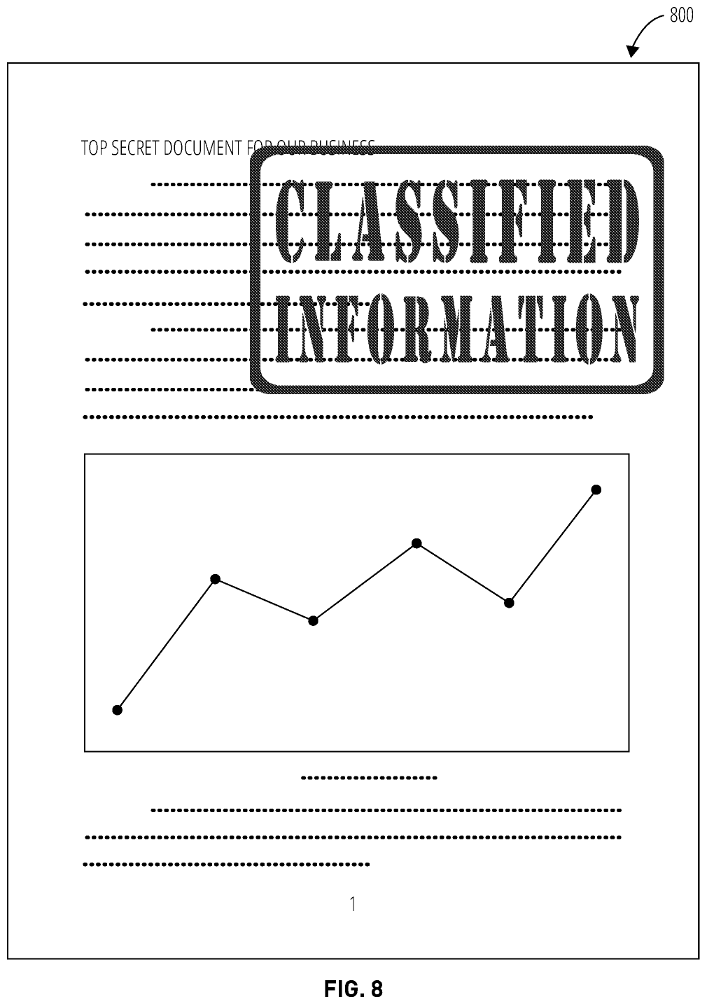

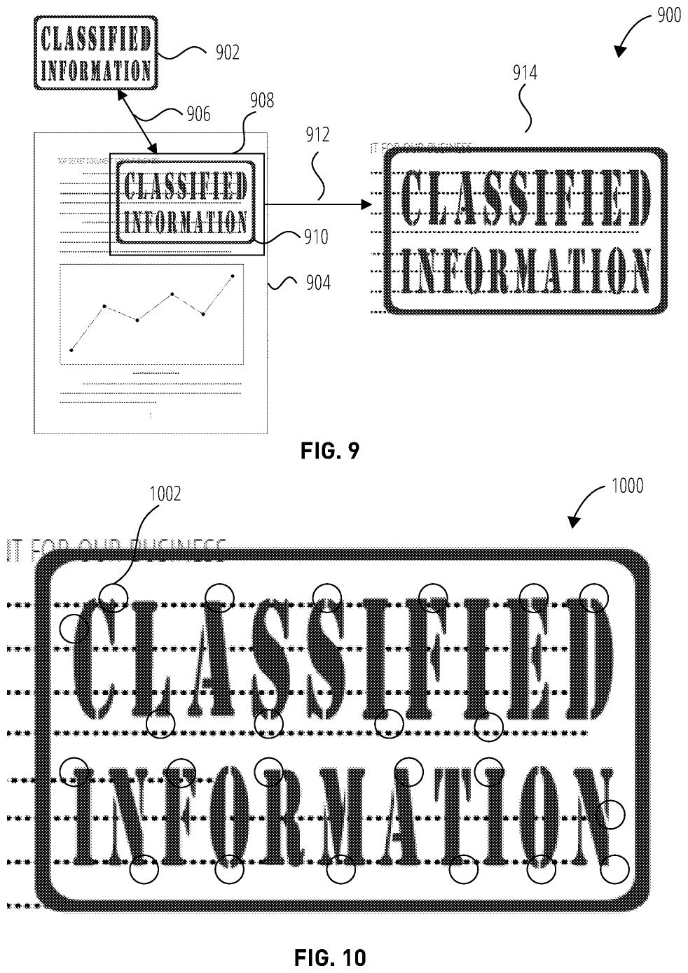

The low resolution original document may be a down-sampled scan of a page inserted into an MFP. For example, in run time, a page scanned at 600 dpi may be downscaled to 100 dpi. The at least one lower resolution template pattern image may be a downscaled version of the original template pattern image. A number of downscaled versions may be created, ranging, in some embodiments, from one tenth to one third the resolution of the original template pattern image. For example, an original 600 dpi template pattern image may be downscaled to a set of template pattern images of 100, 120, 140, 160, 180, and 200 dpi, as described in further detail with respect to FIG. 7A-FIG. 7G. This may be performed by a resize command such as:
resizedT=cv2.resize(template, dimension, interpolation=cv2.INTER_AREA)

Template based pattern matching may be robust against differences in scale up to 20%. For instances where the scale difference between the original template pattern image and a stamp pattern present on the low resolution original document exceed that threshold, more than one of the downscaled, lower resolution template pattern images may be used in multiple loops of template based pattern matching, using additional template matching routine passes to detect scale-varied stamp patterns on the low resolution original document. This may be performed with commands such as:
tp_match=cv2.matchTemplate(pattern, query, cv2.TM_CCOEFF)
min_val, max_val, min_loc, max_loc=cv2.minMaxLoc(tp_match)

The template matching routine(s) may result in a number of match correlation coefficients corresponding to different regions of the low resolution original document. In block 406, a matched region is selected in the low resolution original document based on the match correlation coefficients. The region having the largest match correlation coefficient returned by the template matching routine may be determined to be the matched region, corresponding the region of the low resolution original document that contains a digital stamp pattern.

In block 408, the region in the full resolution original document (e.g., the 600 dpi scanned image) corresponding to the matched region in the low resolution original document may be cropped out to form a cropped region. The cropped region may be considered to be likely to contain a digital stamp pattern and may represent a small area of the full resolution original document.

In block 410, cropped region keypoints and cropped region descriptors may be extracted from the cropped region using Oriented FAST and Rotated BRIEF (ORB) algorithm or a Binary Robust Invariant Scalable Keypoints (BRISK) algorithm. Commands such as the following may be used:
kp2, des2=BRISK.detectAndCompute(img2,None)
   or
kp2, des2=orb.detectAndCompute(img2,None)

In block 412, the cropped region keypoints and cropped region descriptors in the cropped region may be matched with stamp pattern keypoints and stamp pattern descriptors using a feature based pattern matching routine. The feature based pattern matching routine may be a Fast Library for Approximate Nearest Neighbors (FLANN) algorithm, an ORB algorithm, a Scale-Invariant Feature Transform (SIFT) algorithm, or a Speeded Up Robust Features (SURF) algorithm. The command used may be as follows to invoke a FLANN algorithm:
matches=flann.knnMatch(np.asarray(des1,np.float32),np.asarray(des2, np.float32),k=2)

Matches determined to be “good matches” per Lowe's ratio test may be stored for additional computations.

In block 414, a transformation matrix may be computed using coordinates for the stamp pattern keypoints and coordinates for the cropped region keypoints to detect at least one of scaling, rotation, and translation of a detected digital stamp pattern in the cropped region relative to the original template pattern image. This transformation may in one embodiment be run on the above-discussed stored matches. In one embodiment, the transformation matrix may be an affine matrix. Affine transformations are described at a high level with respect to FIG. 12. The command for computing an affine matrix may be:
M, inliers=cv2. estimateAffinePartial2D (src_pts, dst_pts, method=ransacReproj, threshold=3.0, maxIter=2000, confidence=0.97, refineInter=10)

In some embodiments, the transformation matrix may be a homography matrix. Homography mapping is described at a high level with respect to FIG. 13. The command for computing a homography matrix may be:
M, mask=cv2.findHomography(src_pts, dst_pts, cv2.RANSAC,5.0)

In block 416, a number of qualified matches determined using at least one of the feature based pattern matching and the transformation matrix may be checked against a pre-set threshold. If at decision block 418 the number of qualified matches exceeds the pre-set threshold, an alert for a possible security issue may be generated at block 420. If at decision block 418 the number of qualified matches does not exceed the pre-set threshold, a signal indicating no security issues may be generated at block 422.

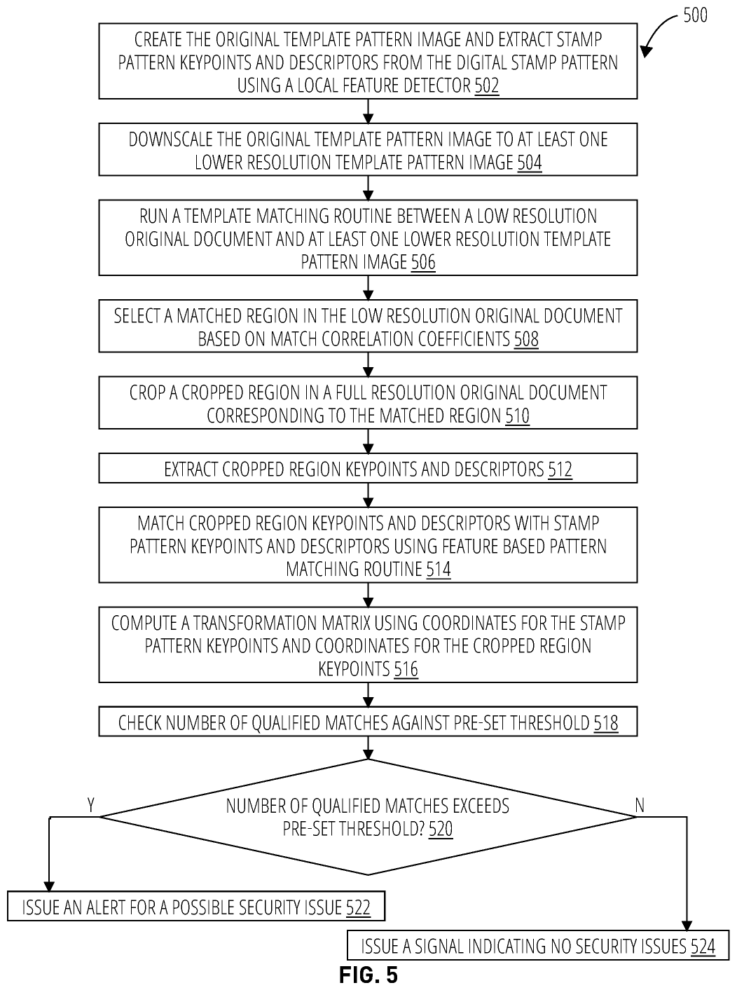

FIG. 5 illustrates a routine 500 in accordance with one embodiment. The routine 500 may begin at block 502, where an original template pattern image is created. Creating the original template pattern image may include extracting stamp pattern keypoints and stamp pattern descriptors from the digital stamp pattern using a local feature detector. The local feature detector may be an Oriented FAST and Rotated BRIEF (ORB) algorithm or a Binary Robust Invariant Scalable Keypoints (BRISK) algorithm. Commands used for this purpose may be as follows:
BRISK=cv.BRISK_create(threshold=30, octaves=3, pattern_scale=2);
kp1, des1=BRISK.detectAndCompute(img1,None)
   or
orb=ev2.0RB_create(2000);
kp1, des1=orb.detectAndCompute(img1,None)

In block 504, original template pattern image may be downscaled to at least one lower resolution template pattern image. In one embodiment, more than one lower resolution template pattern image may be created, and each lower resolution template pattern image may have a unique lower resolution than the original template pattern image. Thus, a number of downscaled versions may be created, ranging, in some embodiments, from one tenth to one third the resolution of the original template pattern image. For example, an original 600 dpi template pattern image may be downscaled to a set of template pattern images of 100, 120, 140, 160, 180, and 200 dpi, as described in further detail with respect to FIG. 7A-FIG. 7G. This may be performed by a resize command such as:
resizedT=cv2.resize(template, dimension, interpolation=cv2.INTER_AREA)

In block 506, a template matching routine may be run between a low resolution original document and at least one lower resolution template pattern image. Template based pattern matching may be run using a template matching routine such as a Python Open Computer Vision (CV) Template Matching algorithm on the low resolution original document and at least one lower resolution template pattern image. The low resolution original document may be a down-sampled scan of a page inserted into an MFP. For example, in run time, a page scanned at 600 dpi may be downscaled to 100 dpi.

The template matching routine(s) may result in a number of match correlation coefficients corresponding to different regions of the low resolution original document. In block 508, a matched region is selected in the low resolution original document based on the match correlation coefficients. The region having the largest match correlation coefficient returned by the template matching routine may be determined to be the matched region, corresponding the region of the low resolution original document that contains a digital stamp pattern.

In block 510, the region in the full resolution original document (e.g., the 600 dpi scanned image) corresponding to the matched region in the low resolution original document may be cropped out to form a cropped region. The cropped region may be considered to be likely to contain a digital stamp pattern and may represent a small area of the full resolution original document.

In block 512, cropped region keypoints and cropped region descriptors may be extracted from the cropped region using Oriented FAST and Rotated BRIEF (ORB) algorithm or a Binary Robust Invariant Scalable Keypoints (BRISK) algorithm. Commands such as the following may be used:
kp2, des2=BRISK.detectAndCompute(img2,None)
   or
kp2, des2=orb.detectAndCompute(img2,None)

In block 514, the cropped region keypoints and cropped region descriptors in the cropped region may be matched with stamp pattern keypoints and stamp pattern descriptors using a feature based pattern matching routine. The feature based pattern matching routine may be a Fast Library for Approximate Nearest Neighbors (FLANN) algorithm, an ORB algorithm, a Scale-Invariant Feature Transform (SIFT) algorithm, or a Speeded Up Robust Features (SURF) algorithm. The command used may be as follows to invoke a FLANN algorithm:
matches=flann.knnMatch(np.asarray(des1,np.float32),np.asarray(des2, np.float32),k=2)

Matches determined to be “good matches” per Lowe's ratio test may be stored for additional computations.

In block 516, a transformation matrix may be computed using coordinates for the stamp pattern keypoints and coordinates for the cropped region keypoints to detect at least one of scaling, rotation, and translation of a detected digital stamp pattern in the cropped region relative to the original template pattern image. This transformation may in one embodiment be run on the above-discussed stored matches. In one embodiment, the transformation matrix may be an affine matrix. Affine transformations are described at a high level with respect to FIG. 12. The command for computing an affine matrix may be:
M, inliers=cv2. estimateAffinePartial2D (src_pts, dst_pts, method=ransacReproj, threshold=3.0, maxIter=2000, confidence=0.97, refineInter=10)

In some embodiments, the transformation matrix may be a homography matrix. Homography mapping is described at a high level with respect to FIG. 13. The command for computing a homography matrix may be:
M, mask=cv2.findHomography(src_pts, dst_pts, cv2.RANSAC,5.0)

In block 518, a number of qualified matches determined using at least one of the feature based pattern matching and the transformation matrix may be checked against a pre-set threshold. If at decision block 520 the number of qualified matches exceeds the pre-set threshold, an alert for a possible security issue may be generated at decision block 522. If at decision block 520 the number of qualified matches does not exceed the pre-set threshold, a signal indicating no security issues may be generated at block 524.

FIG. 6 illustrates an original template pattern image from digital stamp pattern 600 in accordance with one embodiment The digital stamp pattern 602 may be analyzed for stamp pattern keypoints and stamp pattern descriptors 604, identifying unique features found in the image representing the specific digital stamp pattern 602.

FIG. 7A—FIG. 7G illustrate an original template pattern image at 600 dpi 700a in accordance with one embodiment, and a set of lower resolution template pattern images that may be created from the original template pattern image at 600 dpi 700a. Template based pattern matching may tolerate a scale variation of less than 20%. In cases where the scale variation exceeds 20%, multiple template matching operations may be run, each with a different scaled version of the original template pattern image at 600 dpi 700a.

FIG. 7B illustrates a 200 dpi scan 700b of the original template pattern image at 600 dpi 700a in accordance with one embodiment. FIG. 7C illustrates a 180 dpi scan 700c of the original template pattern image at 600 dpi 700a in accordance with one embodiment. FIG. 7D illustrates a 160 dpi scan 700d of the original template pattern image at 600 dpi 700a in accordance with one embodiment. FIG. 7E illustrates a 140 dpi scan 700e of the original template pattern image at 600 dpi 700a in accordance with one embodiment. FIG. 7F illustrates a 120 dpi scan 700f of the original template pattern image at 600 dpi 700a in accordance with one embodiment. FIG. 7G illustrates a 100 dpi scan 700g of the original template pattern image at 600 dpi 700a in accordance with one embodiment.

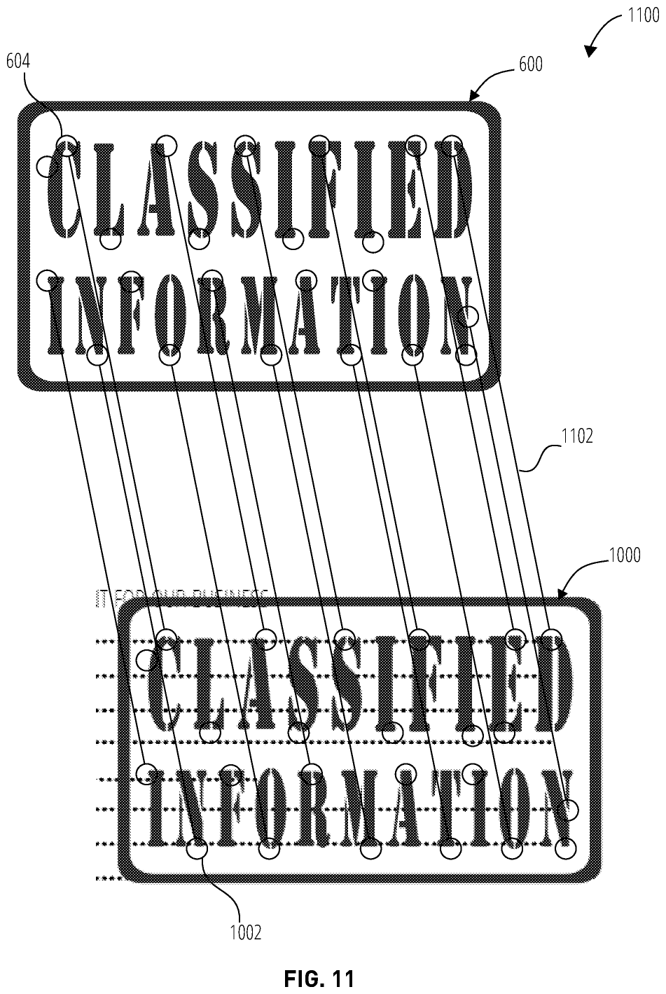

FIG. 8 illustrates a full resolution original document 800 in accordance with one embodiment. A security stamp may be plainly visible to the eye, but may be difficult to detect using conventional approaches, as described with respect to FIG. 2 and FIG. 3.

FIG. 9 illustrates a template matching process 900 in accordance with one embodiment. This template matching process 900 may be completed as part of the routine 400 and routine 500 introduced and described above.

In this template matching process 900, the lower resolution template pattern image 902 may be compared to the low resolution original document 904 using template based pattern matching 906. Template based pattern matching 906 may identify a matched region 908, where the resemblance of a detected digital stamp pattern 910 on the low resolution original document 904 with a lower resolution template pattern image 902 yields high match correlation coefficients.

Cropping 912 an area in the full resolution original documents 800 corresponding to the matched region 908 may yield a cropped region 914. This cropped region 914 at full resolution may represent a richly featured image suitable for comparison with the original template, while still smaller than the entire full resolution original document 800.

FIG. 10 illustrates a cropped region at full resolution 1000 in accordance with one embodiment. The cropped region at full resolution 1000 may be created as illustrated in FIG. 9. Cropped region keypoints and cropped region descriptors 1002 may be identified for the cropped region at full resolution 1000. This may be performed as described with respect to the routine 400 and routine 500 introduced above.

FIG. 11 illustrates a feature matching at full resolution 1100 in accordance with one embodiment. The original template pattern image from digital stamp pattern 600 may be compared with the cropped region at full resolution 1000 using feature based pattern matching 1102. Feature based pattern matching 1102 may identify similarities between the stamp pattern keypoints and stamp pattern descriptors 604 and the cropped region keypoints and cropped region descriptors 1002. These similarities may be deemed qualified matches, and a number of qualified matches exceeding a pre-set threshold may indicate a match with between the page inserted in the printer and a digital stamp pattern.

In one embodiment, where the digital stamp pattern is for a confidentiality or security stamp, a match may generate an alert for a possible security issue. Such a generated alert may result in a number of actions, such as preventing printing of the document inserted into the MFP, sending a security alert email to personnel responsible for managing document security, etc.

In cases where the number of qualified matches does not meet the pre-set threshold, the full resolution original document may be determined not to contain a digital stamp pattern, and a signal indicating no security issues may be generated. In cases where security stamps are of particular interest, documents not containing the digital stamp pattern corresponding to a security stamp, a signal indicating no security issues may trigger the MFP to complete copying, scanning, or printing of the full resolution original document.

FIG. 12 illustrates affine transformation 1200 at a high level. Affine transformation 1200 is a geometric transformation that preserves lines and parallelism, but not necessarily distances and angles. Affine transformations include scaling, such as between View 2 and View 1, rotation, such as View 4 and View 1, reflection, shear, and other similar transformations. Affine transformations may include combinations of these elements, such as the changes in scale and rotation between View 3 and View 1.

Relationships between features within an image such as View 1 are not disturbed by affine transformations. Thus the relationships between features within View 3 may be determined to be similar to the relationships among View 1 features, allowing feature based pattern matching to match View 1 and View 3 as patterns having similarity above a certain threshold, by computing an affine matrix as described with respect to FIG. 4 and FIG. 5. Such computations are well understood in the art.

FIG. 13 illustrates homography transformation 1300 at a high level. Homography transformation 1300 is a process by which features detected on a planar surface may be transformed to represent how those features may appear from differing points of view in a three-dimensional space around the surface. For example, a camera may have View 1 of the features of a planar surface, and another camera may have View 2, as shown. Homographic mapping, performed by computing a homography matrix, may allow correlations between View 1 and View 2 to be detected, and the features present in each view to matched, in spite of the differences engendered in each image based on perspective and distance from the original surface.

View 1 features and View 2 features may be determined to be similar above a certain threshold by computing a homography matrix as described with respect to FIG. 4 and FIG. 5. Such computations are well understood in the art.

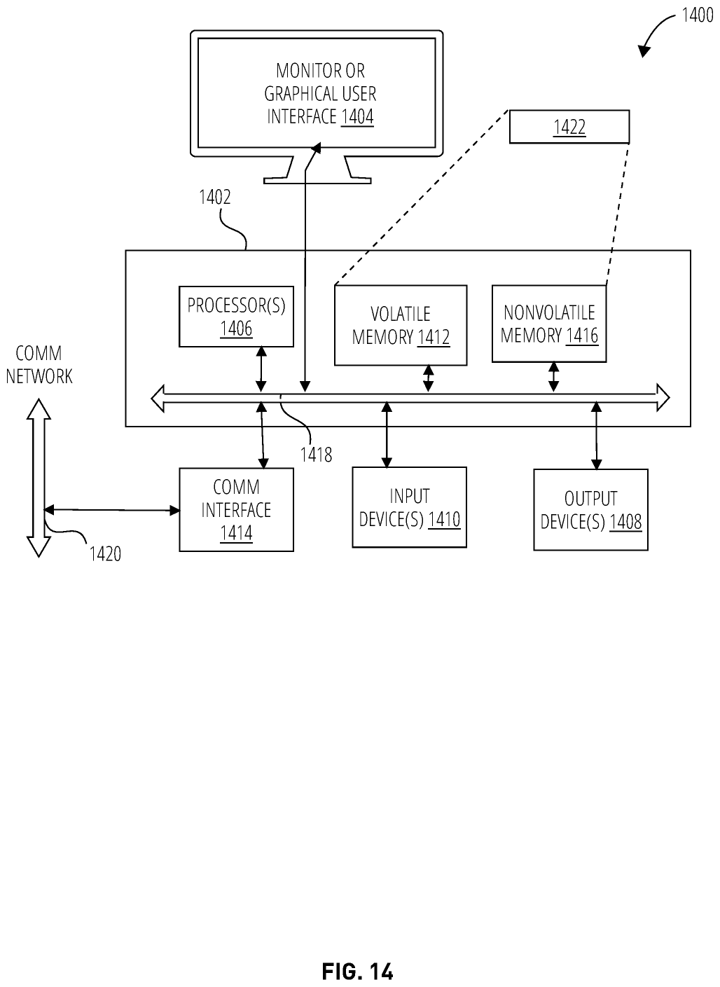

FIG. 14 is an example block diagram of a computing device 1400 that may incorporate embodiments of the present disclosure. FIG. 14 is merely illustrative of a machine system to carry out aspects of the technical processes described herein and does not limit the scope of the claims. One of ordinary skill in the art would recognize other variations, modifications, and alternatives. In one embodiment, the computing device 1400 typically includes a monitor or graphical user interface 1404, a data processing system 1402, a communication network interface 1414, input device(s) 1410, output device(s) 1408, and the like.

As depicted in FIG. 14, the data processing system 1402 may include one or more processor(s) 1406 that communicate with a number of peripheral devices via a bus subsystem 1418. These peripheral devices may include input device(s) 1410, output device(s) 1408, communication network interface 1414, and a storage subsystem, such as a volatile memory 1412 and a nonvolatile memory 1416.

The volatile memory 1412 and/or the nonvolatile memory 1416 may store computer-executable instructions and thus forming logic 1422 that when applied to and executed by the processor(s) 1406 implement embodiments of the processes disclosed herein.

The input device(s) 1410 include devices and mechanisms for inputting information to the data processing system 1402. These may include a keyboard, a keypad, a touch screen incorporated into the monitor or graphical user interface 1404, audio input devices such as voice recognition systems, microphones, and other types of input devices. In various embodiments, the input device(s) 1410 may be embodied as a computer mouse, a trackball, a track pad, a joystick, wireless remote, drawing tablet, voice command system, eye tracking system, and the like. The input device(s) 1410 typically allow a user to select objects, icons, control areas, text and the like that appear on the monitor or graphical user interface 1404 via a command such as a click of a button or the like.

The output device(s) 1408 include devices and mechanisms for outputting information from the data processing system 1402. These may include the monitor or graphical user interface 1404, speakers, printers, infrared LEDs, and so on as well understood in the art.

The communication network interface 1414 provides an interface to communication networks (e.g., communication network 1420) and devices external to the data processing system 1402. The communication network interface 1414 may serve as an interface for receiving data from and transmitting data to other systems. Embodiments of the communication network interface 1414 may include an Ethernet interface, a modem (telephone, satellite, cable, ISDN), (asynchronous) digital subscriber line (DSL), FireWire, USB, a wireless communication interface such as BlueTooth or WiFi, a near field communication wireless interface, a cellular interface, and the like.

The communication network interface 1414 may be coupled to the communication network 1420 via an antenna, a cable, or the like. In some embodiments, the communication network interface 1414 may be physically integrated on a circuit board of the data processing system 1402, or in some cases may be implemented in software or firmware, such as “soft modems”, or the like.

The computing device 1400 may include logic that enables communications over a network using protocols such as HTTP, TCP/IP, RTP/RTSP, IPX, UDP and the like.

The volatile memory 1412 and the nonvolatile memory 1416 are examples of tangible media configured to store computer readable data and instructions to implement various embodiments of the processes described herein. Other types of tangible media include removable memory (e.g., pluggable USB memory devices, mobile device SIM cards), optical storage media such as CD-ROMS, DVDs, semiconductor memories such as flash memories, non-transitory read-only-memories (ROMS), battery-backed volatile memories, networked storage devices, and the like. The volatile memory 1412 and the nonvolatile memory 1416 may be configured to store the basic programming and data constructs that provide the functionality of the disclosed processes and other embodiments thereof that fall within the scope of the present disclosure.

Logic 1422 that implements embodiments of the present disclosure may be stored in the volatile memory 1412 and/or the nonvolatile memory 1416. Said logic 1422 may be read from the volatile memory 1412 and/or nonvolatile memory 1416 and executed by the processor(s) 1406. The volatile memory 1412 and the nonvolatile memory 1416 may also provide a repository for storing data used by the logic 1422.

The volatile memory 1412 and the nonvolatile memory 1416 may include a number of memories including a main random access memory (RAM) for storage of instructions and data during program execution and a read only memory (ROM) in which read-only non-transitory instructions are stored. The volatile memory 1412 and the nonvolatile memory 1416 may include a file storage subsystem providing persistent (non-volatile) storage for program and data files. The volatile memory 1412 and the nonvolatile memory 1416 may include removable storage systems, such as removable flash memory.

The bus subsystem 1418 provides a mechanism for enabling the various components and subsystems of data processing system 1402 communicate with each other as intended. Although the communication network interface 1414 is depicted schematically as a single bus, some embodiments of the bus subsystem 1418 may utilize multiple distinct busses.

It will be readily apparent to one of ordinary skill in the art that the computing device 1400 may be a device such as a smartphone, a desktop computer, a laptop computer, a rack-mounted computer system, a computer server, or a tablet computer device. As commonly known in the art, the computing device 1400 may be implemented as a collection of multiple networked computing devices. Further, the computing device 1400 will typically include operating system logic (not illustrated) the types and nature of which are well known in the art.

Terms used herein should be accorded their ordinary meaning in the relevant arts, or the meaning indicated by their use in context, but if an express definition is provided, that meaning controls.

“Circuitry” in this context refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Firmware” in this context refers to software logic embodied as processor-executable instructions stored in read-only memories or media.

“Hardware” in this context refers to logic embodied as analog or digital circuitry.

“Logic” in this context refers to machine memory circuits, non transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Software” in this context refers to logic implemented as processor-executable instructions in a machine memory (e.g. read/write volatile or nonvolatile memory or media).

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

Various logic functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

### LISTING OF DRAWING ELEMENTS

100 feature based pattern matching flow
102 block
104 block
106 block
108 block
110 block
112 block
200 full page feature extraction
202 full resolution original document
204 copy guard detection stamp
206 feature keypoints and descriptors
300 low resolution feature extraction
302 low resolution original document
304 copy guard detection stamp
306 feature keypoints and descriptors
308 original template pattern image
400 routine
402 block
404 block
406 block
408 block
410 block
412 block
414 block
416 block
418 decision block
420 block
422 block
500 routine
502 block
504 block
506 block
508 block
510 block
512 block
514 block
516 block
518 block
520 decision block
522 block
524 block
600 original template pattern image from digital stamp pattern
602 digital stamp pattern
604 stamp pattern keypoints and stamp pattern descriptors
700a original template pattern image at 600 dpi
700b 200 dpi scan
700c 180 dpi scan
700d 160 dpi scan
700e 140 dpi scan
700f 120 dpi scan
700g 100 dpi scan
800 full resolution original document
900 template matching process
902 lower resolution template pattern image
904 low resolution original document
906 template based pattern matching
908 matched region
910 detected digital stamp pattern
912 cropping
914 cropped region
1000 cropped region at full resolution
1002 cropped region keypoints and cropped region descriptors
1100 feature matching at full resolution
1102 feature based pattern matching
1200 affine transformation
1300 homography transformation
1400 computing device
1402 data processing system
1404 monitor or graphical user interface
1406 processor(s)
1408 output device(s)
1410 input device(s)
1412 volatile memory
1414 communication network interface
1416 nonvolatile memory
1418 bus subsystem
1420 communication network
1422 logic

What is claimed is:

1. A method of detecting a digital stamp pattern, the method comprising:
extracting stamp pattern keypoints and stamp pattern descriptors from an original template pattern image of the digital stamp pattern;
running a template matching routine between:
a low resolution original document; and
at least one lower resolution template pattern image,
wherein match correlation coefficients are determined by regions in the low resolution original document;
selecting a matched region in the low resolution original document based on the match correlation coefficients;
cropping out a cropped region in a full resolution original document corresponding to the matched region in the low resolution original document;
extracting cropped region keypoints and cropped region descriptors in the cropped region;
matching the cropped region keypoints and the cropped region descriptors in the cropped region with the stamp pattern keypoints and the stamp pattern descriptors using a feature based pattern matching routine;
computing a transformation matrix using coordinates for the stamp pattern keypoints and coordinates for the cropped region keypoints to detect at least one of scaling, rotation, and translation of a detected digital stamp pattern in the cropped region relative to the original template pattern image; and
checking a number of qualified matches determined using at least one of the feature based pattern matching and the transformation matrix against a pre-set threshold:
on condition the number of qualified matches exceeds the pre-set threshold, issuing an alert for a possible security issue; and
on condition the number of qualified matches does not exceed the pre-set threshold, issuing a signal indicating no security issues.

2. The method of claim 1, further comprising:
creating the original template pattern image, including extracting the stamp pattern keypoints and the stamp pattern descriptors from the digital stamp pattern using a local feature detector; and
downscaling the original template pattern image to the at least one lower resolution template pattern image, wherein each of the at least one lower resolution template pattern image has a unique lower resolution than the original template pattern image.

3. The method of claim 2, wherein the local feature detector uses at least one of an Oriented FAST and Rotated BRIEF (ORB) algorithm and a Binary Robust Invariant Scalable Keypoints (BRISK) algorithm.

4. The method of claim 1, wherein the original template pattern image has a resolution of six hundred dots per inch.

5. The method of claim 1, the at least one lower resolution template pattern images having resolutions ranging from one tenth to one third the resolution of the original template pattern image.

6. The method of claim 1, wherein the template matching routine uses a Python Open Computer Vision (CV) Template Matching algorithm.

7. The method of claim 1, wherein the feature based pattern matching routine uses at least one of an Oriented FAST and Rotated BRIEF (ORB) algorithm, a Scale-Invariant Feature Transform (SIFT) algorithm, and a Speeded Up Robust Features (SURF) algorithm.

8. The method of claim 1, wherein the transformation matrix is an affine matrix.

9. The method of claim 1, wherein the transformation matrix is a homography matrix.

10. The method of claim 1, wherein computing the transformation matrix includes using a Random Sample Consensus (RANSAC) algorithm.

11. An image analyzing device, comprising:
a processor; and
a memory storing instructions that, when executed by the processor, configure the device to:
extract stamp pattern keypoints and stamp pattern descriptors from an original template pattern image of a digital stamp pattern;
run a template matching routine between:
a low resolution original document; and
at least one lower resolution template pattern image,
wherein match correlation coefficients are determined by regions in the low resolution original document;
select a matched region in the low resolution original document based on the match correlation coefficients;
crop out a cropped region in a full resolution original document corresponding to the matched region in the low resolution original document;
extract cropped region keypoints and cropped region descriptors in the cropped region;
match the cropped region keypoints and the cropped region descriptors in the cropped region with the stamp pattern keypoints and the stamp pattern descriptors using a feature based pattern matching routine;
compute a transformation matrix using coordinates for the stamp pattern keypoints and coordinates for the cropped region keypoints to detect at least one of scaling, rotation, and translation of a detected digital stamp pattern in the cropped region relative to the original template pattern image; and
check a number of qualified matches determined using at least one of the feature based pattern matching and the transformation matrix against a pre-set threshold:
on condition the number of qualified matches exceeds the pre-set threshold, issuing an alert for a possible security issue; and
on condition the number of qualified matches does not exceed the pre-set threshold, issuing a signal indicating no security issues.

12. The image analyzing device of claim 11, wherein the instructions further configure the device to:
create the original template pattern image, including extracting the stamp pattern keypoints and the stamp pattern descriptors from the digital stamp pattern using a local feature detector; and
downscale the original template pattern image to the at least one lower resolution template pattern image, wherein each of the at least one lower resolution template pattern image has a unique lower resolution than the original template pattern image.

13. The image analyzing device of claim 12, wherein the local feature detector uses at least one of an Oriented FAST and Rotated BRIEF (ORB) algorithm and a Binary Robust Invariant Scalable Keypoints (BRISK) algorithm.

14. The image analyzing device of claim 11, wherein the original template pattern image has a resolution of six hundred dots per inch.

15. The image analyzing device of claim 11, the at least one lower resolution template pattern images having resolutions ranging from one tenth to one third the resolution of the original template pattern image.

16. The image analyzing device of claim 11, wherein the template matching routine uses a Python Open Computer Vision (CV) Template Matching algorithm.

17. The image analyzing device of claim 11, wherein the feature based pattern matching routine uses at least one of an Oriented FAST and Rotated BRIEF (ORB) algorithm, a Scale-Invariant Feature Transform (SIFT) algorithm, and a Speeded Up Robust Features (SURF) algorithm.

18. The image analyzing device of claim 11, wherein the transformation matrix is an affine matrix.

19. The image analyzing device of claim 11, wherein the transformation matrix is a homography matrix.

20. The image analyzing device of claim 11, wherein computing the transformation matrix includes using a Random Sample Consensus (RANSAC) algorithm.
